SEQUENCE LISTING (34 sequences)

SEQ ID NO: 1 - DNA, 22 bp, synthetic construct
  source 1..22: mol_type = other DNA
tgcagtgaccaacttcgagatc

SEQ ID NO: 2 - DNA, 22 bp, synthetic construct
  source 1..22: mol_type = other DNA
ggaaacttgaaccaagggctat

SEQ ID NO: 3 - DNA, 22 bp, synthetic construct
  source 1..22: mol_type = other DNA
gcacttaaatattggggtccct

SEQ ID NO: 4 - DNA, 20 bp, synthetic construct
  source 1..20: mol_type = other DNA
atccttgcttgccatcttcc

SEQ ID NO: 5 - DNA, 22 bp, synthetic construct
  source 1..22: mol_type = other DNA
acataagcaacaaaacgacgca

SEQ ID NO: 6 - DNA, 22 bp, synthetic construct
  source 1..22: mol_type = other DNA
cacttgaaggaaatgagggacc

SEQ ID NO: 7 - DNA, 22 bp, synthetic construct
  source 1..22: mol_type = other DNA
acataagcaacaaaacgacgca

SEQ ID NO: 8 - DNA, 22 bp, synthetic construct
  source 1..22: mol_type = other DNA
cacttgaaggaaatgagggacc

SEQ ID NO: 9 - DNA, 18 bp, synthetic construct
  source 1..18: mol_type = other DNA
tggcatcctccccgagat

SEQ ID NO: 10 - DNA, 18 bp, synthetic construct
  source 1..18: mol_type = other DNA
ccgcccgttggaagagtc

SEQ ID NO: 11 - DNA, 22 bp, synthetic construct
  source 1..22: mol_type = other DNA
tccacagcagagctaaacccta

SEQ ID NO: 12 - DNA, 21 bp, synthetic construct
  source 1..21: mol_type = other DNA
aagcaacaagagcccaaatga

SEQ ID NO: 13 - DNA, 20 bp, synthetic construct
  source 1..20: mol_type = other DNA
acggtggttcagtgagggtg

SEQ ID NO: 14 - DNA, 22 bp, synthetic construct
  source 1..22: mol_type = other DNA
cgatggagtatgcgtcaaagtc

SEQ ID NO: 15 - DNA, 19 bp, synthetic construct
  source 1..19: mol_type = other DNA
cgcagcattttccacttcg

SEQ ID NO: 16 - DNA, 21 bp, synthetic construct
  source 1..21: mol_type = other DNA
tcactgtctccgccactcttt

SEQ ID NO: 17 - DNA, 22 bp, synthetic construct
  source 1..22: mol_type = other DNA
acggattactcaatgccaggac

SEQ ID NO: 18 - DNA, 21 bp, synthetic construct
  source 1..21: mol_type = other DNA
gctagcttcaccggtttcaac

SEQ ID NO: 19 - DNA, 18 bp, synthetic construct
  source 1..18: mol_type = other DNA
aatgggcggcggagataa

SEQ ID NO: 20 - DNA, 18 bp, synthetic construct
  source 1..18: mol_type = other DNA
gacggtggtggggctttc

SEQ ID NO: 21 - DNA, 22 bp, synthetic construct
  source 1..22: mol_type = other DNA
gtcgagtcgtcaacgtcctaat

SEQ ID NO: 22 - DNA, 18 bp, synthetic construct
  source 1..18: mol_type = other DNA
cgccgtctcaaaagtccc

SEQ ID NO: 23 - DNA, 20 bp, synthetic construct
  source 1..20: mol_type = other DNA
agtgggcggctgagattaga

SEQ ID NO: 24 - DNA, 21 bp, synthetic construct
  source 1..21: mol_type = other DNA
gcagaatcaacatcaggacgg

SEQ ID NO: 25 - DNA, 22 bp, synthetic construct
  source 1..22: mol_type = other DNA
tcggaaggagtagaagcgatag

SEQ ID NO: 26 - DNA, 19 bp, synthetic construct
  source 1..19: mol_type = other DNA
aagcgtcccagacagagcc

SEQ ID NO: 27 - DNA, 22 bp, synthetic construct
  source 1..22: mol_type = other DNA
gggattaccgggaacagataat

SEQ ID NO: 28 - DNA, 19 bp, synthetic construct
  source 1..19: mol_type = other DNA
ctgagcctttcgaggaggg

SEQ ID NO: 29 - DNA, 20 bp, synthetic construct
  source 1..20: mol_type = other DNA
atcacggaggagaaatggct

SEQ ID NO: 30 - DNA, 20 bp, synthetic construct
  source 1..20: mol_type = other DNA
cttggctggtggttttacga

SEQ ID NO: 31 - DNA, 19 bp, synthetic construct
  source 1..19: mol_type = other DNA
aagcattctgggcaggagc

SEQ ID NO: 32 - DNA, 20 bp, synthetic construct
  source 1..20: mol_type = other DNA
ccttcgttcagagccgtcac

SEQ ID NO: 33 - DNA, 20 bp, synthetic construct
  source 1..20: mol_type = other DNA
gatctgtttcgagccggtct

SEQ ID NO: 34 - DNA, 22 bp, synthetic construct
  source 1..22: mol_type = other DNA
ggagattttacgacgtttctgc

(19) United States
(12) Patent Application Publication
(10) Pub. No.: US 2024/0049705 A1
(43) Pub. Date: Feb. 15, 2024

(54) COMPOSITION FOR ENHANCING GROWTH OF PLANTS

(71) Applicant: INDUSTRY FOUNDATION OF CHONNAM NATIONAL UNIVERSITY, Gwangju (KR)

(72) Inventors: Jangho KIM, Gwangju (KR); Jae Hong KIM, Gyeonggi-do (KR); Sunho PARK, Gwangju (KR)

(21) Appl. No.: 18/375,599

(22) Filed: Oct. 2, 2023

Related U.S. Application Data
(63) Continuation-in-part of application No. 18/226,330, filed on Jan. 1, 0001.

(30) Foreign Application Priority Data
Jul. 26, 2022 (KR) 10-2022-0092386

(51) Int. Cl. A01N 25/24; A01N 25/10; A01P 13/00; A01P 1/00; C05G 3/40

(52) U.S. Cl. CPC A01N 25/24; A01N 25/10; A01P 13/00; A01P 1/00; C05G 3/40

(57) ABSTRACT

A composition for enhancing the growth of a plant may include gelatin having a relatively small diameter so that the composition can be bound or attached to leaves of the plants or the surface of roots thereof. Thus, the growth of the plant treated with the composition may be enhanced.

### CROSS REFERENCE TO RELATED APPLICATIONS AND CLAIM OF PRIORITY

This application is a Continuation-In-Part of co-pending application Ser. No. 18/226,330 filed on Jul. 26, 2023, which claims priority to the benefit of Korean Patent Application No. 10-2022-0092386, filed on Jul. 26, 2022, in the Korean Intellectual Property Office, the entire disclosure of which are incorporated herein by reference for all purposes.

### BACKGROUND

### 1. Field of the Invention

The present invention relates to a composition for enhancing and promoting the growth of plants, which includes gelatin nanoparticles.

### 2. Description of the Related Art

Given the rapid population growth and climate change, the demands for efficient food cultivation and food security are becoming increasingly important. Therefore, various approaches have been proposed to increase crop yield and to protect the growth of crops and vegetation under different environmental conditions, including extreme temperature changes and natural disasters. Among various approaches, attempts to graft nano-technology onto agricultural skills are recently coming in around the world.

Nanoparticles have attracted attention in various biomedical fields, including drug delivery systems and tissue engineering, due to their small size, stability and biocompatibility. In particular, polymer-based nanoparticles showed higher efficiency in targeting diseases because of a more developed encapsulation process than other nanoparticle systems.

The targeting efficiency of these nanoparticles is mainly affected by particle size, surface charge, and surface modification. In particular, the size of the nanoparticles is known to be one of the most important factors that determine interaction with cell membranes and penetration of biological barriers. For example, nanoparticles with a size of less than 100 nm can penetrate various biological barriers such as a brain-blood barrier.

Gelatin, a natural polymer, has many advantages as a material for manufacturing nanoparticles, such as hydrophilicity, biodegradability, non-toxicity, biocompatibility, low price and the like. Because of these various advantages, many researchers have investigated the use of gelatin-based nanoparticles for different biomedical applications. However, gelatin particles prepared using a typical desolvation method in prior studies tended to make the particles unstable and prone to aggregation. In order to overcome these limitations, a two-stage (precipitation-crosslinking) desolvation method capable of producing small gelatin particles that are stable without aggregation has been reported, but the average size of gelatin particles prepared by the existing two-stage desolvation method ranges from 150 to 300 nm, and thus causes problems such as accumulation in large quantities in the liver and spleen.

### SUMMARY

It is an object of the present invention to provide a composition for enhancing the growth of plants, which is absorbed in the plant to accelerate the growth without inhibiting absorption of other nutrients.

To achieve the above object, the following technical solutions are adopted in the present invention.

1. A composition for enhancing the growth of plants, including gelatin nanoparticles.

2. The composition according to the above 1, wherein the nanoparticles have an average diameter of 10 to 200 nm.

3. The composition according to the above 1, wherein the gelatin nanoparticles have a zeta potential of 0 to 50 mV.

4. The composition according to the above 1, wherein the plants are a plant selected from: edible agricultural crops including rice, barley, wheat, proso millet, beans, adzuki beans, millet, sorghum, corn, apple, chestnut, pear, persimmon, strawberry, tomato, eggplant, watermelon, raspberry, oriental melon, taro, chicory, lettuce, sweet potato and potato; or cotton fabric-related garden plants including cotton, rose, chrysanthemum, hydrangea and lawn.

5. The composition according to the above 1, wherein the composition is a spray type formulation.

6. The composition according to the above 1, further including a growth regulator, pesticide, herbicide, anti-microbial agent, anti-viral agent, fertilizer or nutritional supplement carried in the gelatin nanoparticles.

7. A method for production of a composition for enhancing the growth of plants, including: thawing frozen gelatin particles; and cross-linking the same to obtain gelatin nanoparticles.

8. The method according to the above 7, wherein the cross-linking is performed by a reaction with glutaraldehyde.

9. The method according to the above 7, further including: obtaining a gelatin precipitate liquid from the gelatin solution; freezing the same thus to yield the frozen gelatin particles.

10. The method according to the above 7, further including: adding an organic solvent to the cross-linked gelatin particles; purifying the gelatin nanoparticles through centrifugation.

11. The method according to the above 7, further including carrying a growth regulator, pesticide, herbicide, anti-microbial agent, anti-viral agent, fertilizer or nutritional supplement in the gelatin nanoparticles.

12. A method for enhancing the growth of plants, including treating the plants with the composition for enhancing the growth of plants according to any one of the above 1 to 6.

13. The method according to the above 12, wherein the treatment includes injecting the composition for enhancing plant growth to the plants.

The present invention may provide a composition for enhancing the growth of plants, which includes gelatin nanoparticles.

The gelatin nanoparticles may be utilized for a composition to enhance and promote the growth of plants without inhibiting absorption of other nutrients. Preferably, pesticide or herbicide is carried in the gelatin nanoparticles to be absorbed or adsorbed thereto, thereby further enhancing effects thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a method for preparation of gelatin nanoparticles having a small diameter;

FIGS. 2A to 21 illustrate confirmation for specification, substance carrying time and binding force of gelatin nanoparticles to a plant microstructure;

FIGS. 3A to 3C illustrate confirmation for the binding force of gelatin nanoparticles depending on features of plant leaves;

FIGS. 4A to 4K illustrate verification of plant growth promotion depending on whether to treat gelatin nanoparticles or not;

FIG. 5 illustrates confirmation of E. coli growth inhibitory effects depending on whether to treat gelatin nanoparticles or not;

FIGS. 6A to 6J are illustrate schematic views showing an action mechanism of gelatin nanoparticles carried with pesticide and verification of insecticidal effects depending on whether to carry the pesticide in gelatin nanoparticles or not;

FIGS. 7A to 7F illustrate schematic views showing an action mechanism of gelatin nanoparticles carried with herbicide and verification of herbicidal effects depending on whether to carry the herbicide in gelatin nanoparticles or not;

FIGS. 8A to 8G illustrate verification of herbicidal effects depending on whether to carry the herbicide in gelatin nanoparticles or not.

FIGS. 9A and 9B illustrate verification of release tendency of agricultural pesticide over time at different concentrations or different temperatures;

FIG. 10 illustrates verification of residual tendency of agricultural pesticide depending on the number of washes after treatment of gelatin nanoparticles with the agricultural pesticide;

FIG. 11 illustrates measurement of surface charge after treatment of gelatin nanoparticles with agricultural pesticide; and

FIG. 12 illustrates measurement of particle size after treatment of gelatin nanoparticles with agricultural pesticide.

### DETAILED DESCRIPTION

Hereinafter, the present invention will be described in detail. Unless otherwise specifically defined, all terms in the present specification would have the same meanings as general meanings of the corresponding terms understood by persons having common knowledge to which the present invention pertains (“those skilled in the art”), and if the general meanings conflict with the meanings of the terms used herein, the meanings used in the present specification take precedence.

The present invention relates to a composition for enhancing the growth of plants, including gelatin nanoparticles.

The gelatin nanoparticles of the present invention have an average diameter in nano-size, and may be absorbed into cells without preventing absorption of other nutrients during absorption into plants, thereby effectively enhancing the growth of the plants.

The gelatin in the present invention refers to one of derived proteins obtained from collagen, which is a natural protein constituting animal skins, tendon, cartilage, etc. Gelatin may be divided into A type obtained by acid treatment of raw materials and B type obtained by alkaline treatment in a manufacturing process. The gelatin of the present invention may be A type or B type gelatin.

The lower limit of the average diameter of the gelatin nanoparticles is not particularly limited but may be 1 nm, 5 nm, 10 nm, 20 nm or 30 nm. The smaller the average diameter, the less the absorption of nutrients in plants may be inhibited. However, it is not limited thereto.

The upper limit of the average diameter of the gelatin nanoparticles is not particularly limited, but preferably is required to be a size not inhibiting the absorption of nutrients in plants. For example, the upper limit thereof may be 200 nm, 150 nm, 100 nm, 90 nm or 80 nm, but it is not limited thereto.

The gelatin nanoparticles may be positively charged. For example, zeta potential may range from 0 to 50 mV, 5 to 45 mV, 10 to 40 mV, 15 to 35 mV, or 20 to 30 mV, but it is not limited thereto. The above zeta potential may be helpful for attaching the gelatin nanoparticles to plant leaves and/or onto the surface of root cells. The gelatin nanoparticles may be electrically bound to a microstructure in the surface of a leaf or a microstructure in the surface of a root, and may be still maintained with being attached to the surface even when washed with water several times.

The structure of gelatin nanoparticles is not particularly limited. For example, the gelatin nanoparticles may have a structure such as spherical, elliptical, tetrahedral, hexahedral, octahedral, decahedral, dodecahedral, icosahedral, tetrahexahedral, hexoctahedral or diamond-shaped dodecahedral structure. Preferably, the gelatin nanoparticles may have a spherical structure with a constant surface curvature.

In the present invention, the plants may be selected without limitation by those skilled in the art so far as they need protein and/or amino acid for constituting gelatin for enhancing the growth of plants. For example, the plants may be edible agricultural crops such as rice, barley, wheat, proso millet, beans, adzuki beans, millet, sorghum, corn, apple, chestnut, pear, persimmon, strawberry, tomato, eggplant, watermelon, raspberry, oriental melon, taro, chicory, lettuce, sweet potato, potato, etc.; garden plants such as cotton, rose, cactus chrysanthemum, hydrangea, lawn, etc.; or industrial agricultural crops such as sugar cane, tobacco, canola, etc., however, they are not limited thereto.

Further, the gelatin nanoparticles of the present invention may carry a substance helpful for plant growth therein. The substance may include, for example, a growth regulator, pesticide, herbicide, an anti-microbial agent, an anti-viral agent, fertilizer or nutritional supplements or the like. The gelatin nanoparticles may carry/absorb/adsorb a material, and may gradually release the material over time. In this process, effects of the material may be exhibited. Further, the gelatin nanoparticles after discharging the material may additionally execute inherent or original functions thereof, thereby further enhancing the growth of plants or the like.

The growth regulator, pesticide, herbicide, anti-microbial agent, anti-viral agent, fertilizer or nutritional supplements may be carried/absorbed/adsorbed in the gelatin nanoparticles, therefore, may be included in the range of the present invention without limitations thereof so far as the above agents can be included in the composition for enhancing the growth of plants.

The growth regulator may be selected without limitation thereof so far as it can enhance the growth of plants, and for example, may be any plant hormone such as auxin, cytokinin or ethylene, or a compound capable of enhancing the growth of plants, but it is not limited thereto.

The herbicide or pesticide may be contained without a limitation to the content thereof to the composition. For example, the content thereof may be 0.1% by weight (“wt. %”), 0.5 wt. %, 1 wt. %, 2 wt. %, 5 wt. %, etc., based on the composition, but it is not limited thereto.

The composition of herbicide or pesticide may be rapidly discharged in the early 3 days due to a weak mechanical property of gelatin as well as adsorption to an outer surface of nanoparticle, and may involve a difference in concentration due to a diffusion phenomenon in relation to release of a model drug from the nanoparticles. Release curves may be a little altered according to the concentration, however, show all similar trend of gradually discharging the composition. Further, a rapid release rate was shown for the early 3 days at different temperatures, and similar results were also obtained. With the passing of time, specific peaks related to agricultural pesticides became decreased in the nanoparticles loaded with the agricultural pesticide, and therefore it could be understood that the agricultural pesticide may be gradually discharged from the nanoparticles. The above result suggests that the nanoparticles may possibly function as a carrier for controlled release of agricultural pesticides, and it may further provide an implication of improvement in effects of agricultural pesticide application and safety.

In the present invention, the composition may be formulated in a unit dose form using any acceptable carrier and/or excipient, or may be formulated by introducing the same into a multi-dose container according to any method easily implemented by those skilled in the art, to which the present invention pertains. At this time, the formulation may have the form of a solution, suspension or emulsion in oil or aqueous medium, or the form of extract, powder, tablets or capsules, and may further contain a dispersing agent or stabilizer. The formulation is preferably a spray type formulation. When the spray type composition of the present invention is sprayed, it may exist in the air for a longer time due to a small particle size than the large particles, and may be sprayed over a long distance so that plants inhabiting in a wide range of area can be easily treated with the composition for a long period of time. Furthermore, due to the inherent zeta potential as described above, if the composition is sprayed in the form of a spray type formulation, it may be better bound to a microstructure of plant leaf thus to perform inherent function for a long period of time, but it is not limited thereto.

Further, the present invention relates to a method for production of a composition for enhancing the growth of plants, which includes: thawing frozen gelatin particles; and cross-linking the same to obtain gelatin nanoparticles.

The gelatin particle refers to gelatin in a granular form, and for example, may be obtained by precipitation after dissolving the gelatin.

The freezing means decreasing a temperature of gelatin particles to a lower temperature than room temperature. The frozen gelatin particles are not particularly limited so far as a volume of the gelatin particles is reduced than a volume thereof at room temperature due to the decreased temperature, and a freezing temperature may include cryogenic temperatures. The freezing may be deep-freezing, and the deep-freezing refers to a method for preservation of a substance by rapidly decreasing a temperature of the substance. The deep-freezing may be performed, for example, through a deep-freezer. A deep-freezing method may include, for example, blast freezing using cold air; contact freezing by circulating a coolant in a shelf; or cryogenic freezing method using liquid nitrogen, but it is not limited thereto.

The frozen gelatin particles may be, for example, gelatin particles dispersed and frozen in a solvent. In this case, the gelatin particles dispersed in the solvent may be the particles frozen to a temperature lower than a melting point of the solvent, and the solvent may be, for example, water.

The thawing refers to raising a temperature of gelatin particles between the freezing temperature and room temperature. Therefore, a step of cross-linking while thawing may mean cross-linking conducted in a state in which the gelatin particles are not completely returned to a state before freezing. The thawing may be conducted, for example, under refrigeration and a refrigeration temperature may be, for example, in a range of 0 to 10° C.

The cross-linking means that chain-shaped gelatin molecules constituting the gelatin particles are linked to each other by chemical bonds. The step of cross-linking the gelatin may be performed by a typical cross-linking process that can be appropriately selected by those skilled in the art, and it is not particularly limited thereto. For example, cross-linking of gelatin may be performed by a reaction with glutaraldehyde or genipin.

If the frozen gelatin particles are frozen gelatin particles dispersed in a solvent, it is difficult to react with a cross-linking agent in a frozen state. Therefore, bringing the cross-linking agent into contact with the gelatin particles in the solvent while thawing the particles may result in cross-linking. If the gelatin particles are completely thawed and the temperature is increased, the volume will expand again thus to perform cross-linking before completely thawing. Further, if the frozen gelatin particles are frozen gelatin particles dispersed in the solvent, cross-linking may be conducted before completely thawing, for example, in the presence of thin ice.

The production method may further include obtaining a gelatin precipitate liquid from the gelatin solution, and freezing the same to prepare the frozen gelatin particles.

The precipitate liquid means that the gelatin in the gelatin solution reaches saturation and comes out of the solution, and the method of obtaining the gelatin precipitate liquid from the gelatin solution may be carried out through a precipitation reaction that can be appropriately selected by those skilled in the art with common knowledge, but it is not particularly limited. For example, a gelatin precipitation reaction may occur by adding a precipitation reagent to the gelatin solution. The gelatin solution may be obtained, for example, by dissolving gelatin in a solvent (e.g., water) at 40 to 60° C., wherein, for example, in the case of the gelatin aqueous solution, the precipitation reagent may be selected from acetone, ethanol, picric acid solution and chromium trioxide solution, but it is not limited thereto. Amounts of the solvent and reagent used in the precipitation reaction, pH, temperature, etc. may be appropriately selected by those skilled in the art according to the purpose of implementation.

The production method may further include precipitating gelatin in the gelatin solution; re-dissolving the precipitate; re-precipitating the same after acid addition thus to obtain a gelatin precipitate liquid; and freezing the precipitate liquid thus to prepare the frozen gelatin particles.

The pH of the gelatin solution before the precipitation reaction may influence on a shape and size of the gelatin particles prepared through precipitation. The acid addition may reduce the pH of the gelatin solution thereby increasing surface charge of gelatin molecules in the solution. As a result, a repulsive force between the gelatin molecules may allow the shape of the gelatin particles produced during the precipitation reaction to become uniform and small. The pH of the gelatin solution obtained through the acid addition may be, for example, 2 to 4, specifically 3. The acid may be HCl, but it is not limited thereto.

The production method may further include adding an organic solvent to the cross-linked gelatin particles, and purifying the gelatin nanoparticles through centrifugation.

The organic solvent may be selected from acetone, acetonitrile, chloroform, methanol, and ethanol, but it is not limited thereto.

The purification may be carried out under refrigeration. The refrigeration temperature may range, for example, from 0 to 10° C., but it is not limited thereto.

The production method may further include carrying the growth regulator, pesticide, herbicide, anti-microbial agent, anti-viral agent, fertilizer or nutritional supplement into the gelatin nanoparticles. The carrying step preferably includes: after purifying the gelatin nanoparticles, mixing a substance intended to be carried into a solution containing gelatin nanoparticles so as to enable the substance to be carried/absorbed or adsorbed inside the nanoparticles, but it is not limited thereto. Instead, any method used by those skilled in the art may be adopted. Further, in the above-described process of preparing nanoparticles, the pesticide, herbicide, anti-microbial agent, anti-viral agent, fertilizer or nutritional supplement may be mixed together to be carried, absorbed or adsorbed in the nanoparticles, followed by purifying the nanoparticles.

Further, the present invention relates to a method for enhancing the growth of plants, which includes treating the plants with the composition for enhancing the growth of plants as described above.

The treatment process described above may be appropriately selected so far as the composition for enhancing the growth of plants can come into contact with the body of plants such as leaves, roots, etc. For example, the composition may be mixed in a culture medium for cultivating the plants, may be sprayed into soil, or may be sprayed in the air to be delivered into the air. Preferably, when using a method of injecting the composition for enhancing plant growth to the plants, the gelatin nanoparticles may be stayed in the air for a long period of time or be widely diffused due to a small particle size, such that effects of the composition can act on a wider range of plants for a long period of time, but it is not limited thereto.

Hereinafter, the present invention will be described in more detail by way of the following examples in order to concretely describe the present invention.

### Example 1. Preparation of Gelatin Nanoparticles (GNPs)

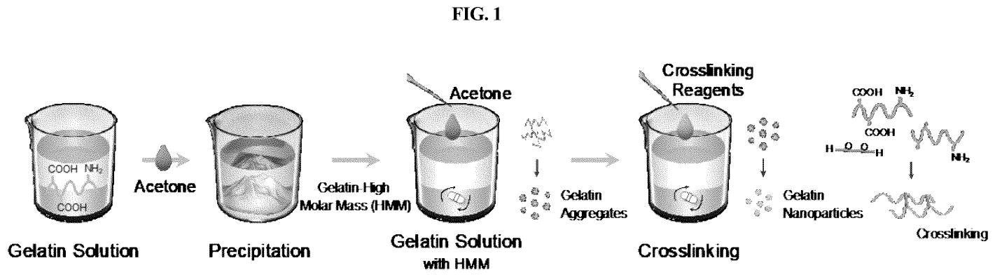

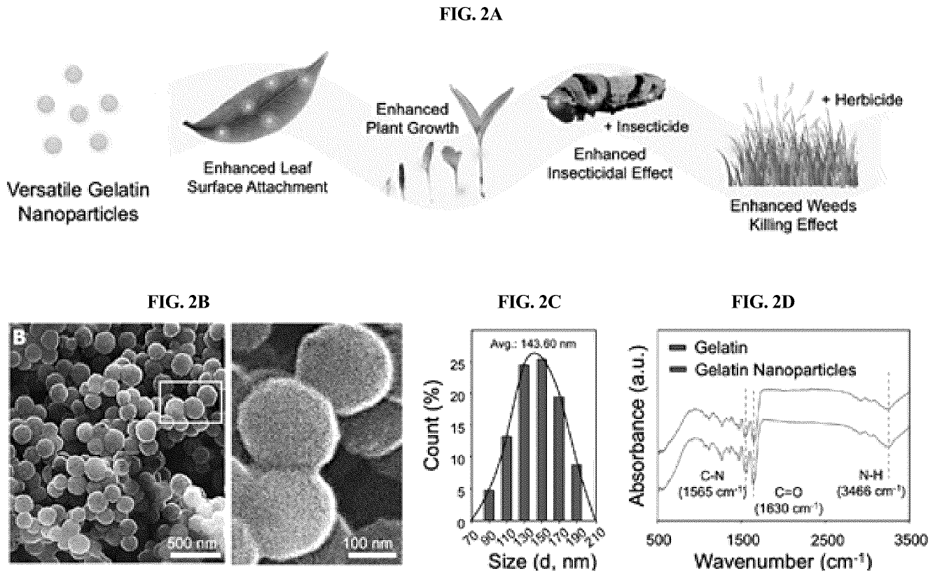

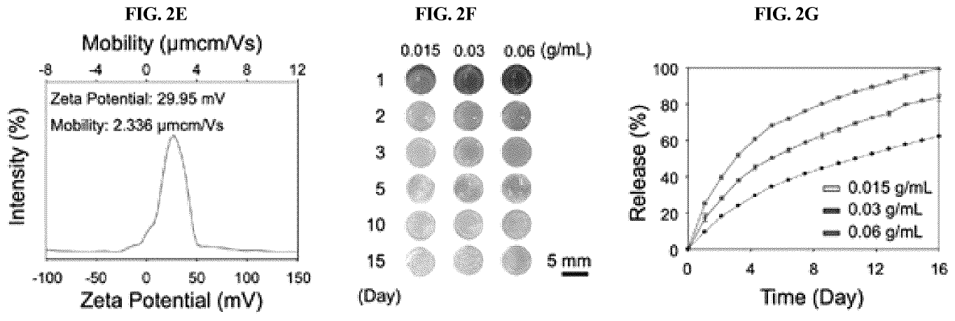

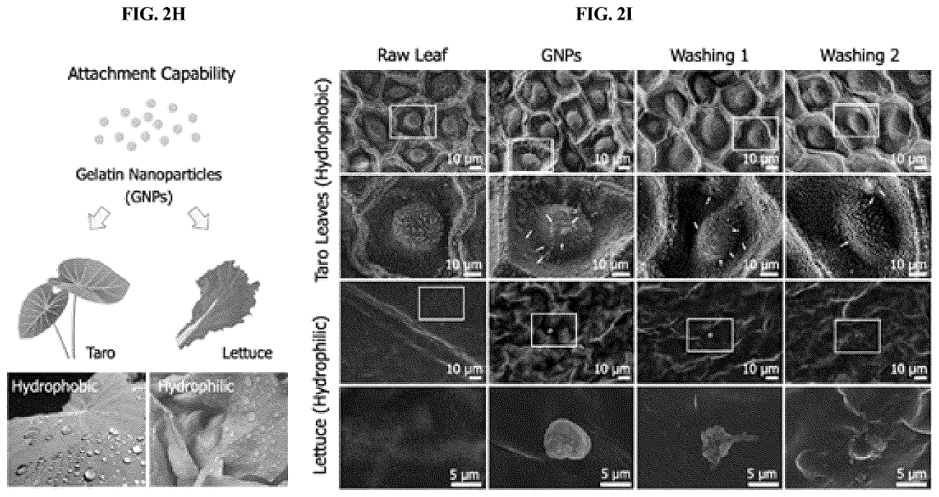

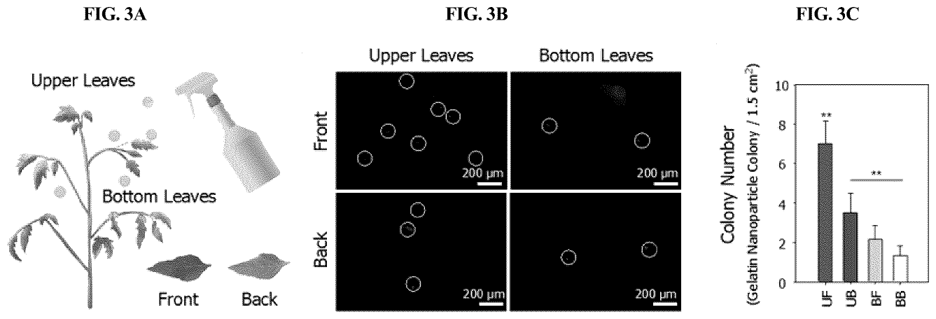

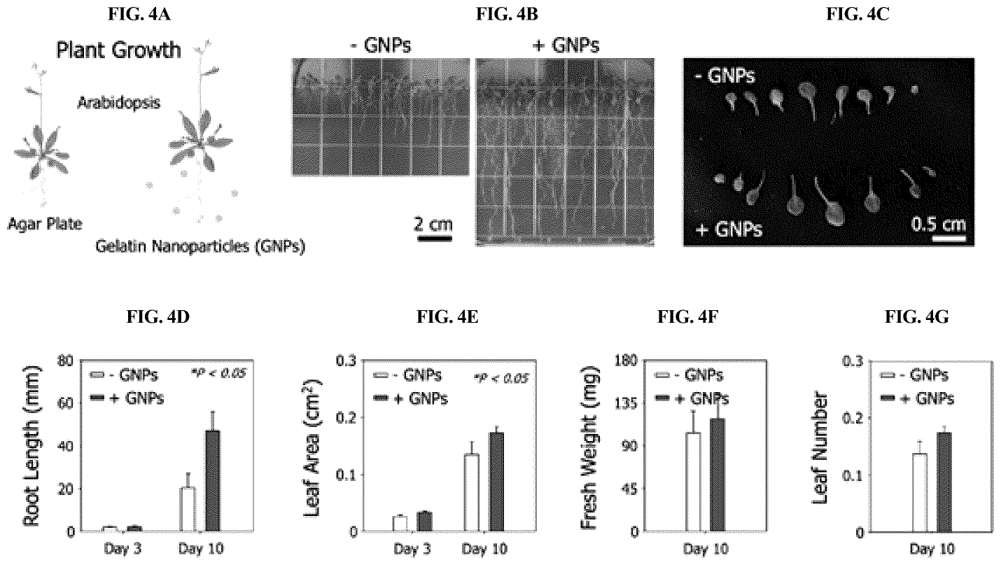

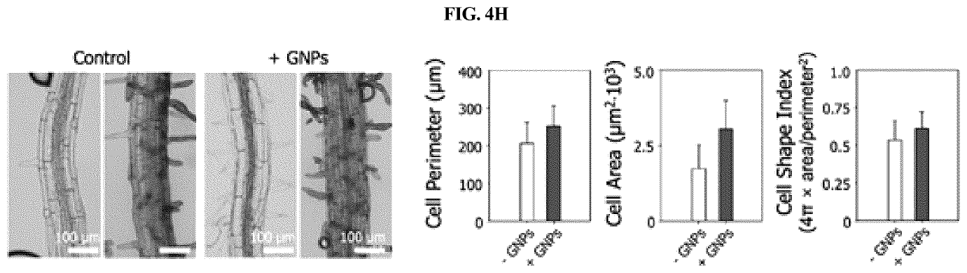

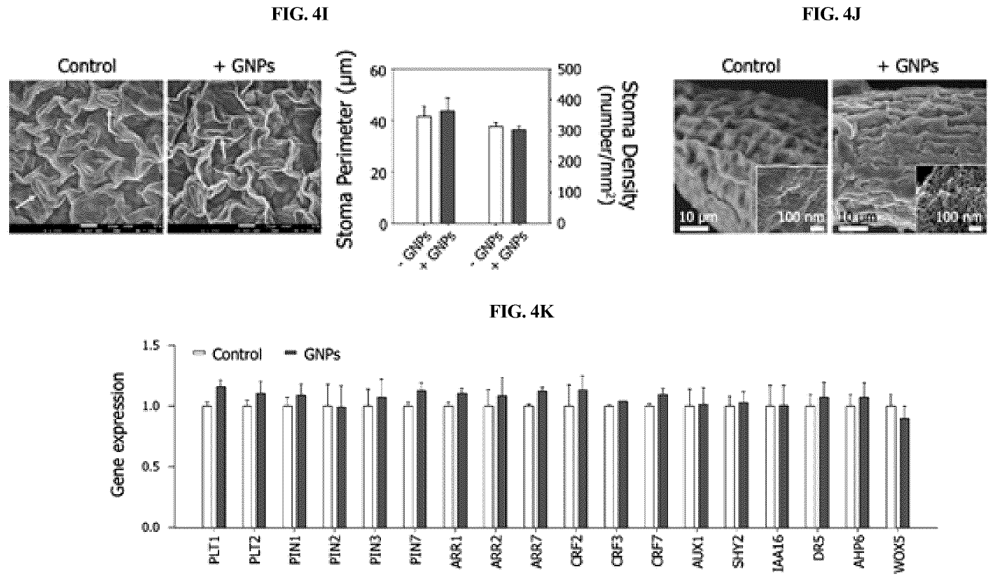

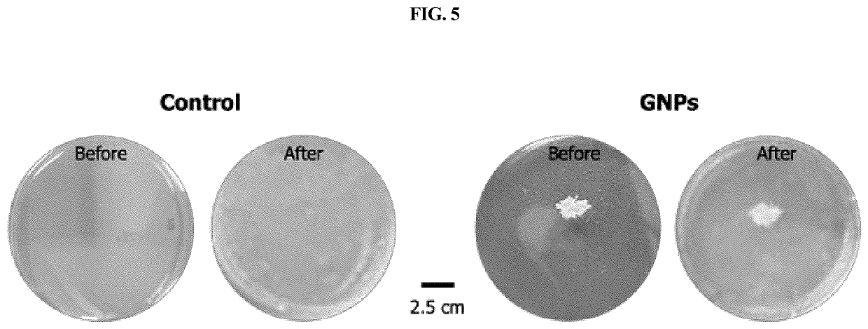

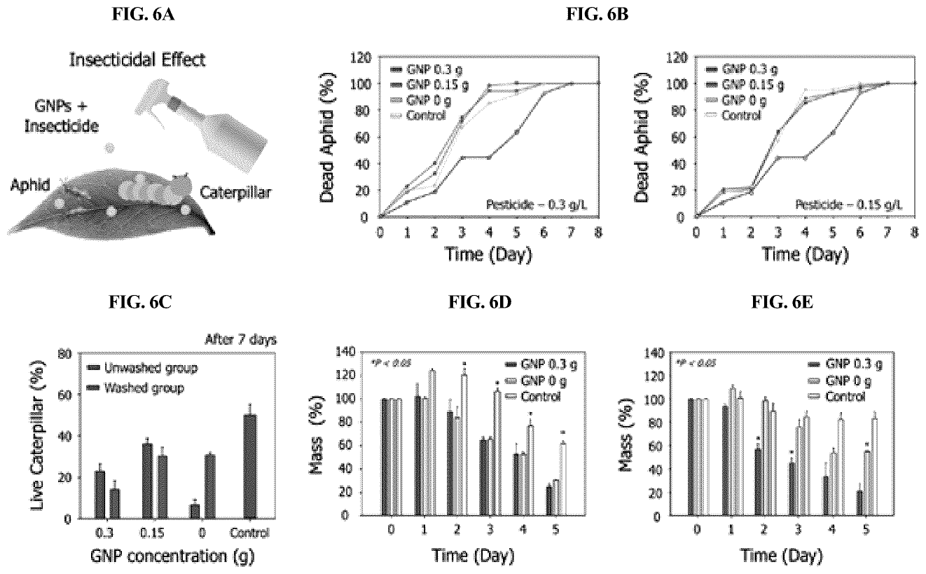

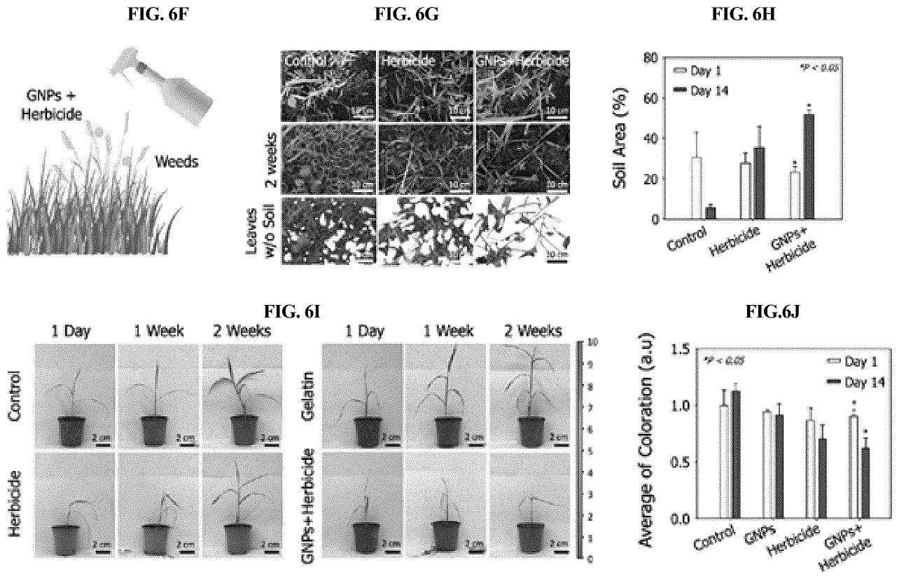

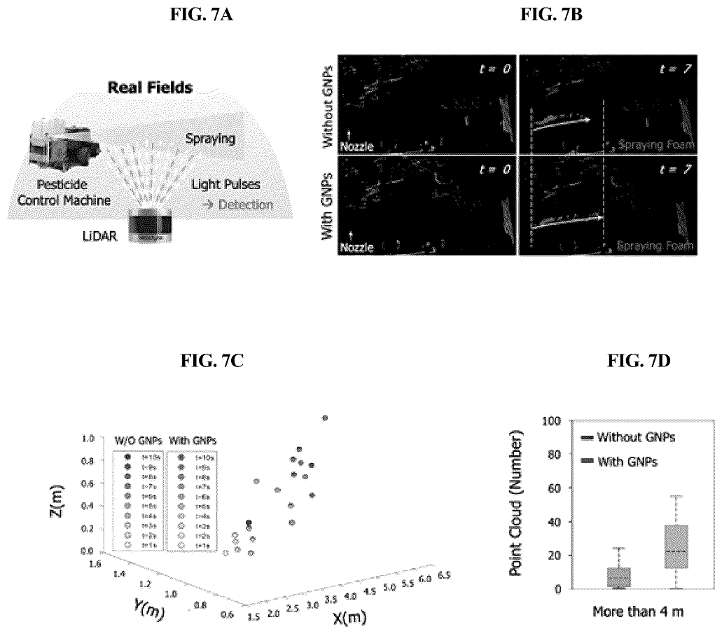

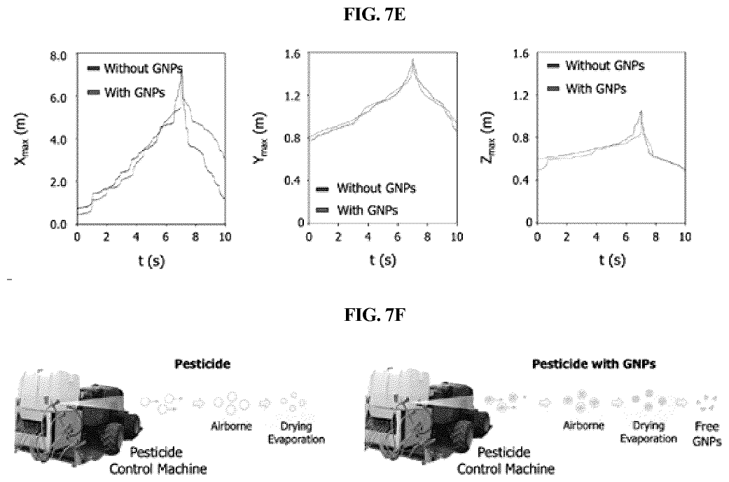

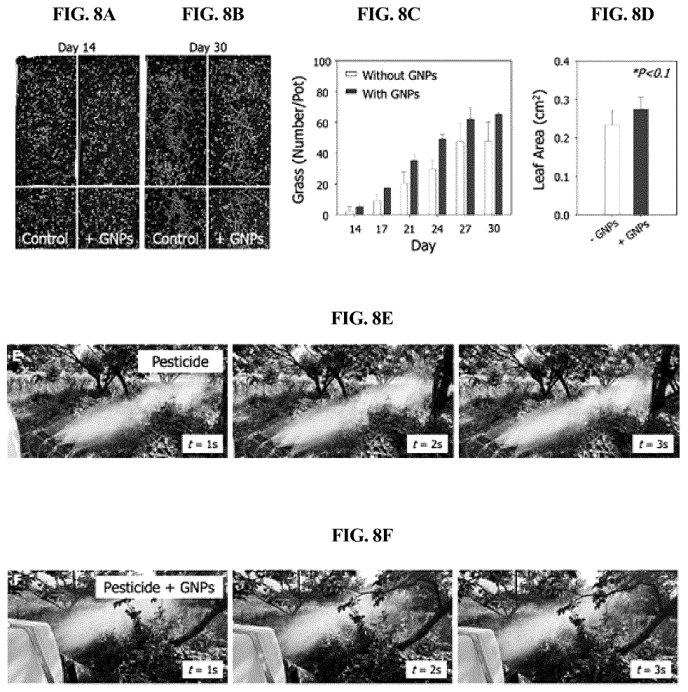

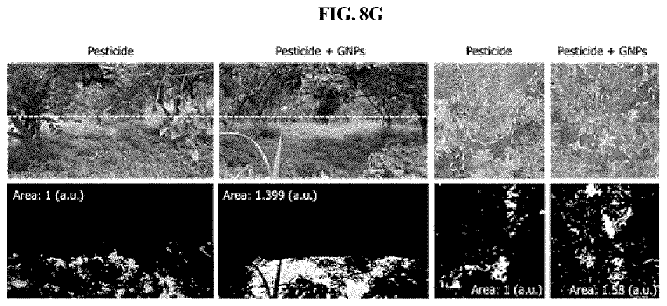

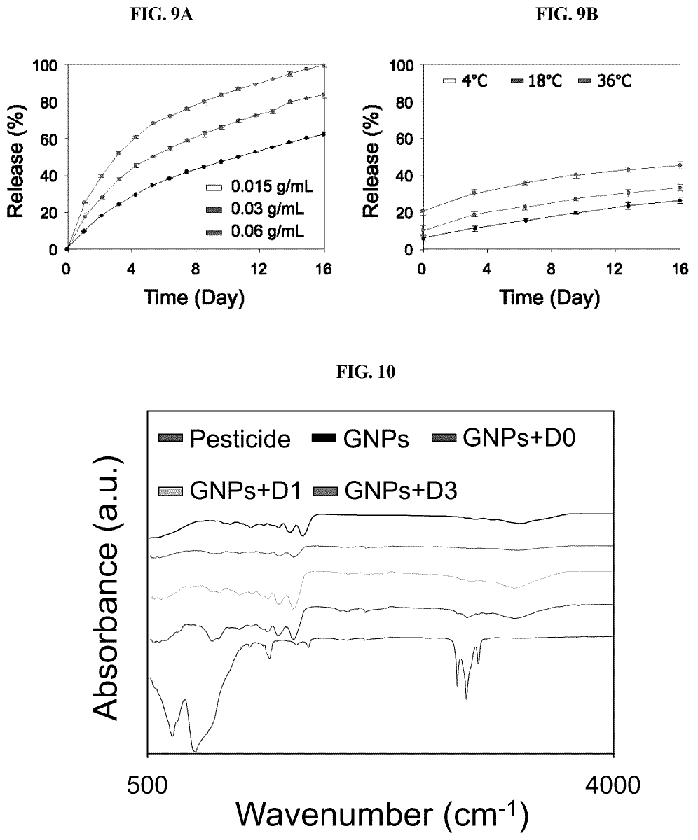

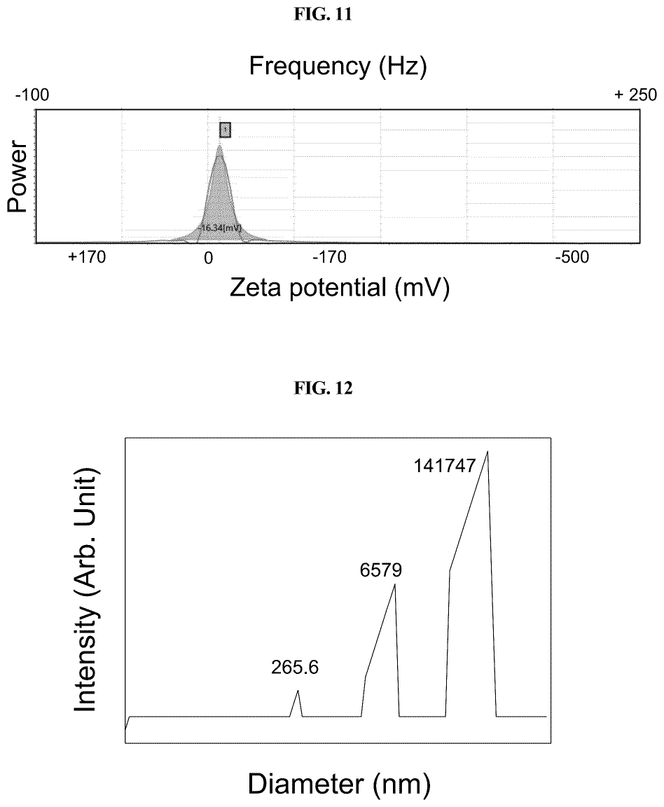

For preparation of GNPs having a stable size distribution, a two-staged dissolution process was performed. Specifically, gelatin powder (Gelatin type A, Sigma Aldrich, St. Louis, MO, USA) was introduced into 25 mL distilled water to reach 5.0% (w/v), and dissolved with stirring while heating at 50° C. Following this, 25 mL of acetone was added to the gelatin solution and then the gelatin precipitate having a high molar mass was stirred to be resolved in 25 mL of distilled water at 50° C. The pH of the solution was adjusted to 3 using HCl. 75 mL of acetone was further slowly added to the solution and admixed together for 1 hour at 600 rpm and 40° C. Then, about 60 mL of acetone was introduced into the mixture, and when the solution becomes milky, it entered a laboratory chamber at 4° C., followed by mixing the same for 1 hour. Thereafter, 280 μL of 25% (v/v) glutaraldehyde as a cross-linker was slowly added to the solution, followed by mixing the same in the laboratory chamber at 4° C. overnight. After centrifugation at 4° C. and 6,500 rpm, gelatin nanoparticles were washed with 75% acetone three times, followed by freeze-drying for 4 days (FIG. 1).

### Example 2. Confirmation of Features of GNPs

GNPs prepared in Example 1 were observed by a field-emission scanning electron microscope (FE-SEM; JSM-7500F, JEOL, Ltd. Tokyo, Japan) to confirm a shape of particles. SEM images were processed by image J software (National Institutes of Health, Bethesda, MD, USA) in order to quantify a size of the GNPs. Chemical properties of the GNPs were analyzed through FT-IR spectroscopy. Zeta potential was analyzed using a zeta-potential and particle size analyzer (ELSZ-2000, Otsuka, Electronics CO., Ltd., Osaka, Japan), while physical properties were analyzed using an MCT 1150 system (AND, Korea).

In order to confirm drug release features, trypan blue was used as a model drug. Specifically, 0.03 g of GNPs was reacted with 0.015 g/mL, 0.03 g/mL and 0.06 g/mL of trypan blue, respectively, and then left at room temperature for 2 hours. Thereafter, the amount of released trypan blue solution was measured using a UV visible spectrophotometer to determine absorbance at a wavelength of 595 nm.

### Example 3. SEM Image Assay of Plants According to GNPs Treatment

GNPs were dispersed in distilled water to reach 0.03 g/100 mL and treated on fresh taro or lettuce leaves at a distance of 30 cm. Surfaces of the leaves were dried, then washed once or twice with pure distilled water. Arabidopsis Thaliana L was cultivated in an agar medium containing GNPs or another agar medium not containing GNPs, respectively, for 2 weeks. Thereafter, taro, lettuce and Arabidopsis Thaliana L leaf samples were gently separated, treated with 4% paraformaldehyde (Sigma Aldrich) for 10 minutes to be fixed, and washed with 1×PBS three times, then reacted in 1% osmium tetroxide (Sigma Aldrich) for 1 hour. Thereafter, the reacted product was washed again with 1×PBS three times, and dehydrated with ethanol solutions by gradually increasing concentrations to 30%, 50%, 70%, 80%, 90% and 100% v/v. Thereafter, the samples were coated with a Pt layer at a thickness of more or less 5 nm, followed by monitoring images using JSM-7500F FE-SEM device (JEOL Ltd.).

### Example 4. Preparation of GNPs Culture Medium and Assessment of Growth Change of Plants Depending on Whether to Include GNPs or not

GNPs were sonicated in 1 L distilled water so as to be a concentration of 0.03 g GNP/100 mL, and mixed together. 2.2 g of Murashige and Skoog medium (MS), 10 g of agar (DUCHEFA, Haarlem, The Netherlands), 0.5 g of 2-(N-morpholino) ethane sulfonic acid powder (Sigma-Aldrich, St. Louis, MO, USA), and 30 g of sucrose were introduced into GNPs solution, and then mixed together. The pH of the solution was adjusted to reach 5.6 to 5.8. MS medium including GNPs (GNPs/MS medium) was sterilized in an autoclave (DH18CAT00210081, Daihan Scientific), and then dried in a sterile hood. Seeds of Arabidopsis Thaliana L were sterilized with a solution containing 70% ethanol and 20% sodium hypochlorite, and then seeded in MS medium at 4° C. under dark conditions. After 3 days, the germinated seeds were replanted in MS medium or GNPs/MS medium and then grown at 24° C. Each germination assay (n=4) was performed using 90 to 100 seeds. Then, in order to investigate effects of GNPs on the growth, root length, leaf size, total weight and the number of leaves, the plants were measured at each point of day 3 and day 10, respectively, after the seeds were planted in the MS medium or GNPs/MS medium.

### Example 5. Analysis of Plant Gene Expression

In order to confirm expression amounts of genes related to the root growth, a reverse transcription-quantitative polymerase chain reaction (RT-qPCR) was conducted. In order to obtain 300 nucleotide fragments, mRNA was treated with RNA fragmentation buffer (10 mM Tris-HCl, pH 7.0, 10 mM ZnCl₂), and the prepared RNA and immune-precipitated RNA were subjected to reverse transcription using reverse transcription enzyme and arbitrary hexamer primer. Further, the amount of each transcriptome was measured through CR by means of Rotor-Gene Q thermal cycler (Qiagen, Hilden, Germany) and using SyBR Green PCR kit (Qiagen, Hilden, Germany) as well as gene-specific primer. The list for primers specific to genes is shown in Table 1 below.

TABLE 1

| Name of | | | |
|---|---|---|---|
| primer | Direction | Nucleotide sequence | Sequence No. |
| PLT1 | Forward | TGCAGTGACCAACTTCGAGATC | SEQ ID NO: 1 |
| | Reverse | GGAAACTTGAACCAAGGGCTAT | SEQ ID NO: 2 |
| PLT2 | Forward | GCACTTAAATATTGGGGTCCCT | SEQ ID NO: 3 |
| | Reverse | ATCCTTGCTTGCCATCTTCC | SEQ ID NO: 4 |
| PIN1 | Forward | ACATAAGCAACAAAACGACGCA | SEQ ID NO: 5 |
| | Reverse | CACTTGAAGGAAATGAGGGACC | SEQ ID NO: 6 |
| PIN2 | Forward | ACATAAGCAACAAAACGACGCA | SEQ ID NO: 7 |
| | Reverse | CACTTGAAGGAAATGAGGGACC | SEQ ID NO: 8 |
| PIN3 | Forward | TGGCATCCTCCCCGAGAT | SEQ ID NO: 9 |
| | Reverse | CCGCCCGTTGGAAGAGTC | SEQ ID NO: 10 |
| PIN7 | Forward | TCCACAGCAGAGCTAAACCCTA | SEQ ID NO: 11 |
| | Reverse | AAGCAACAAGAGCCCAAATGA | SEQ ID NO: 12 |
| ARR1 | Forward | ACGGTGGTTCAGTGAGGGTG | SEQ ID NO: 13 |
| | Reverse | CGATGGAGTATGCGTCAAAGTC | SEQ ID NO: 14 |
| ARR2 | Forward | CGCAGCATTTTCCACTTCG | SEQ ID NO: 15 |
| | Reverse | TCACTGTCTCCGCCACTCTTT | SEQ ID NO: 16 |
| ARR7 | Forward | ACGGATTACTCAATGCCAGGAC | SEQ ID NO: 17 |
| | Reverse | GCTAGCTTCACCGGTTTCAAC | SEQ ID NO: 18 |
| CRF2 | Forward | AATGGGCGGCGGAGATAA | SEQ ID NO: 19 |
| | Reverse | GACGGTGGTGGGGCTTTC | SEQ ID NO: 20 |
| CRF3 | Forward | GTCGAGTCGTCAACGTCCTAAT | SEQ ID NO: 21 |
| | Reverse | CGCCGTCTCAAAAGTCCC | SEQ ID NO: 22 |
| CRF7 | Forward | AGTGGGCGGCTGAGATTAGA | SEQ ID NO: 23 |
| | Reverse | GCAGAATCAACATCAGGACGG | SEQ ID NO: 24 |
| AUX1 | Forward | TCGGAAGGAGTAGAAGCGATAG | SEQ ID NO: 25 |
| | Reverse | AAGCGTCCCAGACAGAGCC | SEQ ID NO: 26 |
| SHY2 | Forward | GGGATTACCGGGAACAGATAAT | SEQ ID NO: 27 |
| | Reverse | CTGAGCCTTTCGAGGAGGG | SEQ ID NO: 28 |
| IAA16 | Forward | ATCACGGAGGAGAAATGGCT | SEQ ID NO: 29 |
| | Reverse | CTTGGCTGGTGGTTTTACGA | SEQ ID NO: 30 |
| DR5 | Forward | AAGCATTCTGGGCAGGAGC | SEQ ID NO: 31 |
| | Reverse | CCTTCGTTCAGAGCCGTCAC | SEQ ID NO: 32 |
| WOX5 | Forward | GATCTGTTTCGAGCCGGTCT | SEQ ID NO: 33 |
| | Reverse | GGAGATTTTACGACGTTTCTGC | SEQ ID NO: 34 |

### Example 6. Confirmation of In Vivo Insecticidal Effect

5o Aphis gossypii were collected from red pepper plants, and 5 cabbage white butterfly caterpillars were purchased from WANI Science (Seoul, Korea). These insects were treated with a mixture of diluted pesticide solution (Setis, Faramhannong, Seoul, Korea) and GNPs prepared as shown in Table 2 below while breeding on the leaves. Thereafter, in order to investigate insecticidal effects of the residual GNPs, distilled water was sprayed on the sample 20 times. The number and size of dead insects were measured every day.

TABLE 2
Substance contained in pesticide solution (in 1000 mL of
pure distilled water)

| | |
|---|---|
| Pesticide 0.03 g + GNPs 0 g | Pesticide 0.015 g + GNPs |
| | 0 g |
| Pesticide 0.03 g + GNPs | Pesticide 0.015 g + GNPs |
| 0.0075 g | 0.0075 g |
| Pesticide 0.03 g + GNPs | Pesticide 0.015 g + GNPs |
| 0.015 g | 0.015 g |
| Pesticide 0.03 g + GNPs 0.03 g | Pesticide 0.015 g + GNPs |
| | 0.03 g |

### Example 7. Confirmation of In Vitro Herbicidal Effects

In order to evaluate effects of the herbicide (0.03 g/L, Terado, Farmhannong, Seoul, Korea) depending on whether to include GNPs (0.03 g) or not, weeds were used. Specifically, the herbicide solution was sprayed on the weeds for 2 weeks by once per week, followed by collecting images every day. Then, quantification was conducted using image J software.

### Example 8. Spray Type Analysis Depending on Whether to Include GNPs or not Through LiDAR

Small droplets sprayed from a pesticide spray machine were obtained for 10 seconds as point cloud data using LiDAR (Puck, Velodyne Lidar, CA, USA), and an outer surface part of an object was measured using 3D LiDAR photogrammetry software (Veloview, CA, USA). A three-dimensional morphology was formed by the obtained point cloud data, wherein each position was indicated by Cartesian coordinates (x, y and z). Through a set of interested regions, the spray form was classified into specific point clouds, wherein each point cloud was calculated by MATLAB (MatWorks, MA, USA). In order to verify effects of nanoparticles on the spray distance, a critical value was set to 4 m or more which is close to the maximum spray distance. The classified point clouds were defined by Equation 1 below.

p(a₁,a₂, . . . ,aₙ)=Σp_{sf}=Σ_{a∈p}_{ₛₜ}pₐ+Σ_{b∈p}_{ₛₜ}p_{b} [Equation 1]

### Example 9. Statistical Assay

T-test was performed based on data obtained under two separate conditions, and comparison between 3 or more groups was analyzed by a test of one-way analysis of variance, wherein a difference with p value of less than 0.05 was considered to be statistically significant (*p<0.05). All quantitative results were indicated by mean±standard deviation (S.D.).

### REFERENCE TO AN ELECTRONIC SEQUENCE LISTING

A sequence listing electronically submitted on Oct. 2, 2023 as a XML file named 20231002_LC0582310-CIP_TU_SEQ.XML, created on Sep. 20, 2023 and having a size of 31,017 bytes, is incorporated herein by reference in its entirety.

What is claimed is:

1. A method for enhancing the growth of a plant, the method comprising:
treating the plant with a composition comprising a gelatin nanoparticle.

2. The method according to claim 1, wherein the nanoparticle has an average diameter of 10 to 200 nm.

3. The method according to claim 1, wherein the gelatin nanoparticle has a zeta potential of 0 to 50 mV.

4. The method according to claim 1, wherein the plant is selected from the group consisting of an edible agricultural crop and a cotton fabric-related garden plant.

5. The method according to claim 1, wherein the plant is selected from the group consisting of rice, barley, wheat, proso millet, beans, adzuki beans, millet, sorghum, corn, apple, chestnut, pear, persimmon, strawberry, tomato, eggplant, watermelon, raspberry, oriental melon, taro, chicory, lettuce, sweet potato and potato.

6. The method according to claim 1, wherein the plant is selected from the group consisting of cotton, rose, chrysanthemum, hydrangea and lawn.

7. The method according to claim 1, wherein the composition is a spray type formulation.

8. The method according to claim 1, wherein the composition further comprises a growth regulator, pesticide, herbicide, anti-microbial agent, anti-viral agent, fertilizer, and/or nutritional supplement carried in the gelatin nanoparticle.

9. The method according to claim 1, wherein the composition is injected into the plant.

10. The method according to claim 1, wherein the composition is prepared by a process comprising:
thawing a frozen gelatin particle; and
cross-linking the same to obtain the gelatin nanoparticle.

11. The method according to claim 10, wherein the cross-linking is performed by a reaction with glutaraldehyde.

12. The method according to claim 10, wherein the process further comprises:
obtaining a gelatin precipitate liquid from a gelatin solution; and
freezing the same to yield the frozen gelatin particle.

13. The method according to claim 10, wherein the process further comprises:
adding an organic solvent to the cross-linked gelatin particle; and
purifying the gelatin nanoparticle through centrifugation.

14. The method according to claim 10, wherein the process further comprises:
carrying a growth regulator, pesticide, herbicide, anti-microbial agent, anti-viral agent, fertilizer and/or nutritional supplement in the gelatin nanoparticle.
